(19) United States
(12) Patent Application Publication
(10) Pub. No.: US 2024/0083333 A1
(43) Pub. Date: Mar. 14, 2024

(54) TRAILER FOR TRANSPORTING AERIAL LIFTS

(71) Applicant: Kevin Allen Varnadore, Jupiter, FL (US)

(72) Inventor: Kevin Allen Varnadore, Jupiter, FL (US)

(21) Appl. No.: 18/243,235

(22) Filed: Sep. 7, 2023

Related U.S. Application Data
(60) Provisional application No. 63/405,567, filed on Sep. 12, 2022.

(51) Int. Cl. B60P 3/28; B60D 1/66; B62D 63/06; B62D 63/08

(52) U.S. Cl. CPC B60P 3/28; B60D 1/665; B62D 63/062; B62D 63/08

(57) ABSTRACT

Disclosed is a trailer for transporting an aerial mast lift comprising a frame to provide a support to a first set of components of the trailer including, but not limited to, self-aligning mounting brackets provided on a rear side of the frame to receive a receiving handle of an aerial mast lift. The self-aligning brackets allow for ease of folding and loading of the aerial mast lift onto the trailer. The trailer further comprises a rail to allow for movement of the aerial mast when positioning the loaded aerial mast lift on the trailer. The trailer further comprises a tongue extended forward from the frame and designed to provide a support to a second set of components of the trailer.

### CROSS REFERENCE TO RELATED APPLICATION

This application claims benefit and priority to U.S. Provisional Patent Application Ser. No. 63/405,567, filed Sep. 12, 2022, entitled, “TRAILER FOR TRANSPORTING AERIAL LIFTS” which is incorporated herein by reference in its entirety.

### FIELD OF INVENTION

Embodiments disclosed herein relate, in general, to trailers, and more particularly, to a trailer for transporting aerial mast lifts.

### BACKGROUND

Aerial lifts such as vertical mast lifts, boom lifts, scissor lifts, and the like (collectively referred to as “aerial mast lifts”) have been designed to lift individuals and construction material to a designated height. Traditionally, smaller aerial mast lifts are configured with handles and wheels to enable a user to manually maneuver the aerial mast lifts on a site by a pushing/pulling motion. However, transportation of the aerial mast lift from one worksite to another often necessitates a use of vehicles like a pick-up truck, a high roof cargo van, or a similarly sized vehicle due to the need to accommodate the considerable space required for transport, which, in turn, leaves less space available for tools and cargo. Although larger drivable aerial mast lifts have been developed, they tend to be more complex, have a more specified usage and require much larger means of transport.

To overcome the aforementioned issues, a variety of trailers have been designed for the transportation of the aerial mast lifts. However, loading/unloading and securing of aerial mast lifts onto a traditional trailer often requires considerable time and manpower. Moreover, when aerial mast lifts are loaded onto a traditional trailer, they are in a vertical position which will lead to a higher center of gravity causing the aerial mast lifts to easily shift or tip over during transport if not properly secured. In addition, existing traditional trailers lack a capability to tilt or recline the aerial mast lifts again resulting in a higher center of gravity during transport. Additionally, existing traditional trailers lack integrated attachment methods to secure an aerial mast lift, making loading, securing, and unloading onto the trailer more challenging.

Therefore, there is a need for an improved and advanced trailer that enables the aerial mast lift to be reclined and folded for easier and more efficient loading, securing and/or unloading onto the trailer.

### SUMMARY

Embodiments in accordance with the present invention provide a trailer for ease in transporting an aerial mast lift. The trailer comprises a frame designed to provide support to a first set of components of the trailer. The first set of components comprises one or more mounting brackets provided on the rear side of the frame. The one or more mounting brackets are self-aligning mounting brackets enabling one or more receiving handles of an aerial mast lift to be aligned with the one or more mounting brackets. Once aligned, the receiving handle of the aerial mast lift moves freely within the self-aligning mounting bracket to form a pivot point to enable ease of folding and loading of the aerial mast lift onto the trailer in a horizontal position. The first set of components further comprises one or more rails attached over the frame to enable the folded aerial mast lift to be positioned in a desired location on the trailer. In a preferred embodiment to the present invention, the rails enable the aerial mast lift to be moved in a forward direction on the trailer when the aerial mast lift is loaded over the trailer. The trailer further comprises a tongue extended forward from the frame and designed to provide a support to a second set of components of the trailer.

Embodiments in accordance with the present invention further provide a trailer for transporting an aerial mast lift. The trailer comprises a frame designed to provide support to a first set of components of the trailer. The first set of components comprise one or more mounting brackets provided on the rear side of the frame. The one or more mounting brackets are self-aligning mounting brackets enabling one or more receiving handles of an aerial mast lift to be aligned with the one or more mounting brackets. Once aligned, the receiving handle of the aerial mast lift moves freely within the self-aligning mounting bracket to form a pivot point to enable ease of folding and loading of the aerial mast lift onto the trailer in a horizontal position. The first set of components further comprises one or more rails attached over the frame, to enable the folded aerial mast lift to move in a forward direction on the trailer when the aerial mast lift is loaded over the trailer. The first set of components further comprises a bumper stop that serves as a stopping point for the movement of the aerial mast lift along the one or more rails. The trailer further comprises a tongue extended forward from the frame and designed to provide a support to a second set of components of the trailer.

Embodiments in accordance with the present invention further provide a method of loading an aerial mast lift onto a trailer. The method comprises the steps of enabling a user to align the one or more receiving handles of the aerial mast lift with one or more mounting brackets for fitting together the one or more mounting brackets with corresponding one or more receiving handles of the aerial mast lift; enabling the user to load the aerial mast lift onto the trailer by folding the aerial mast lift in a downward and horizontal position upon aligning the receiving brackets of the aerial mast lift with the mounting brackets of the aerial mast trailer; enabling the user to push the aerial mast lift onto the trailer in a forward direction through one or more rails; and enabling the user to fasten the loaded aerial mast lift by using an integrated fastening means provided at a tongue of the trailer to securely hold the aerial mast lift onto the trailer. In another embodiment of the present invention, when folded on the trailer, the aerial mast lift may be pushed in a forward direction to abut the bumper stop so as to prevent further forward movement.

Embodiments of the present invention may provide a number of advantages depending on its particular configuration. First, embodiments of the present invention may provide an easily transportable trailer that may be designed to transport aerial mast lifts.

Next, embodiments of the present invention may provide a trailer that may comprise a hinge or pivot function to allow an aerial mast lift to be tilted or folded in a downward position while loading the aerial mast lift onto the trailer.

Next, embodiments of the present invention may provide a trailer designed to be light weight and compact making it movable by a single person when not attached to a vehicle even with an aerial mast lift loaded onto the trailer.

Next, embodiments of the present invention may provide a trailer designed to provide an ease of transport by eliminating a need of a truck, a high roof cargo van, and so forth for pickup of aerial mast lifts. This allows smaller vehicles, including smaller utility vans, passenger cars, and even golf carts for non-highway transport, to carry out pickup and transportation of the aerial mast lifts, providing a more efficient and versatile solution.

Next, embodiments of the present invention may provide a trailer designed for ease of assembly and disassembly for ease of transport and shipping and distribution of the trailer.

These and other advantages will be apparent from the present application of the embodiments described herein.

The preceding is a simplified summary to provide an understanding of some embodiments of the present invention. This summary is neither an extensive nor exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The foregoing and other aspects of the embodiments disclosed herein are best understood from the following detailed description when read in connection with the accompanying drawings. For the purpose of illustrating the embodiments disclosed herein, there is shown in the drawings embodiments that are presently preferred, it being understood, however, that the embodiments disclosed herein are not limited to the specific instrumentalities disclosed. Included in the drawings are the following figures:

FIG. 1A illustrates a trailer, according to an embodiment of the present invention;

FIG. 1B illustrates components of the trailer, according to an embodiment of the present invention;

FIG. 1C illustrates the trailer loaded with an aerial mast lift, according to an embodiment of the present invention;

FIG. 2A illustrates a trailer, according to another embodiment of the present invention;

FIG. 2B illustrates a rear view of the trailer, according to another embodiment of the present invention;

FIG. 2C illustrates a front view of the trailer, according to another embodiment of the present invention;

FIG. 2D illustrates a side view of the trailer, according to another embodiment of the present invention;

FIG. 2E illustrates the aerial mast lift placed behind the trailer in a vertical position, according to another embodiment of the present invention;

FIG. 3 illustrates a flow chart of a method of manufacturing of the trailer, according to an embodiment of the present invention;

FIG. 4 illustrates a flow chart of a method of manufacturing of the trailer, according to another embodiment of the present invention

FIG. 5 illustrates a flow chart of a method of loading the aerial mast lift onto the trailer, according to an embodiment of the present invention; and

FIG. 6 illustrates a flow chart of a method of unloading the aerial mast lift from the trailer, according to an embodiment of the present invention;

FIG. 7 illustrates a flow chart of a method of loading the aerial mast lift onto the trailer, according to another embodiment of the present invention; and

FIG. 8 illustrates a flow chart of a method of unloading the aerial mast lift from the trailer, according to another embodiment of the present invention.

While embodiments of the present invention are described herein by way of example using several illustrative drawings, those skilled in the art will recognize the present invention is not limited to the embodiments or drawings described. It should be understood the drawings and the detailed description thereto are not intended to limit the present invention to the particular form disclosed, but to the contrary, the present invention is to cover all modification, equivalents and alternatives falling within the spirit and scope of embodiments of the present invention as defined by the appended claims.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present invention will be described below in conjunction with an exemplary trailer for transporting aerial mast lifts. Embodiments of the present invention are not limited to any particular type of a trailer for transporting aerial mast lifts. Those skilled in the art will recognize the disclosed techniques may be used in any trailer for transporting aerial mast lifts.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

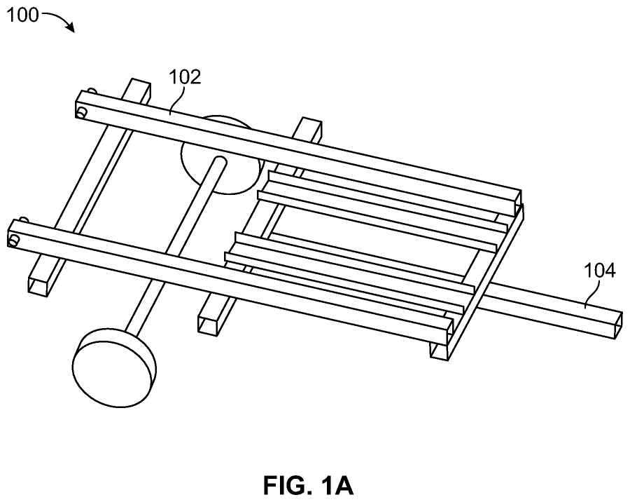

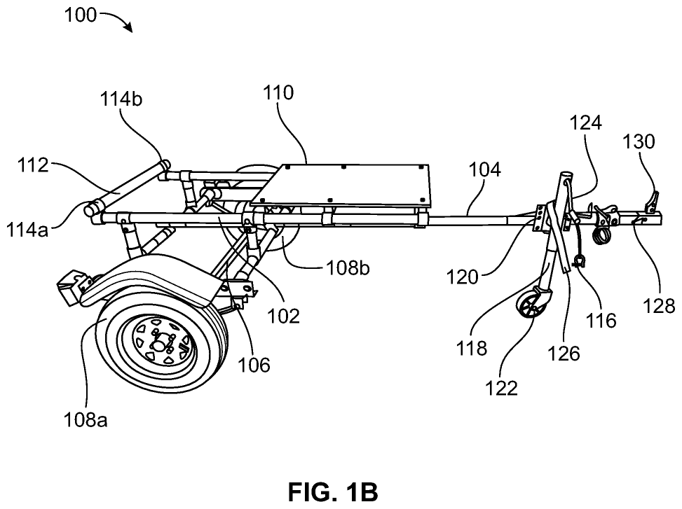

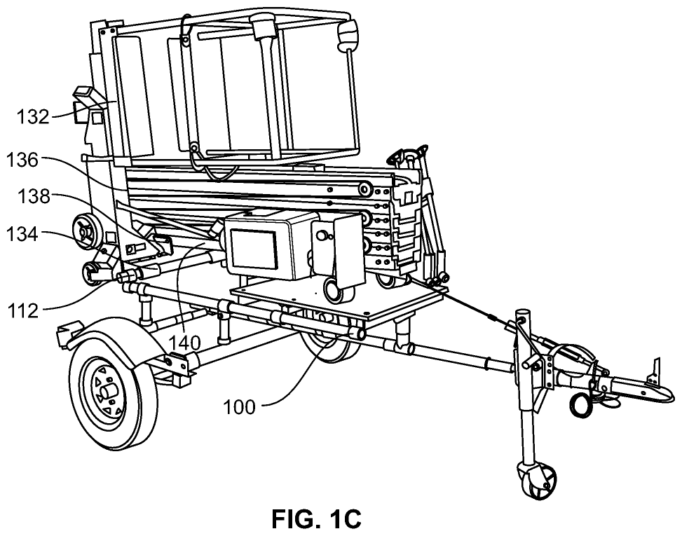

FIG. 1A illustrates a trailer 100, according to an embodiment of the present invention. In an embodiment of the present invention, the trailer 100 may be designed to transport an aerial mast lift 132 (as shown in FIG. 1C) from one location to another location. In an embodiment of the present invention, the aerial mast lift 132 may be, but not limited to, a boom lift, a scissor lift, and so forth. In a preferred embodiment of the present invention, the aerial mast lift 132 may be a vertical mast lift. Embodiments of the present invention are intended to include or otherwise cover any type of the aerial mast lift 132 to be transported by the trailer 100 including known related art and/or later developed technologies. Further, in an embodiment of the present invention, the trailer 100 may be designed to be compact which in turn saves space. Furthermore, in an embodiment of the present invention, the trailer 100 may be adapted to provide an ease of transport by eliminating a need of a heavy transportation vehicle, including but not limited to, a truck, a cargo van, and so forth for pickup of the aerial mast lift 132. Embodiments of the present invention are intended to include or otherwise cover any type of heavy transportation vehicle including known related art and/or later developed technologies.

According to embodiments of the present invention, the trailer 100 may comprise a frame 102 and a tongue 104. The frame 102 may be designed to provide a support to a first set of components of the trailer 100, in an embodiment of the present invention. The first set of components may be, but not limited to, at least one axle 106 (hereinafter referred to as the axle 106, as shown in FIG. 1B), at least two wheels 108a-108b (hereinafter referred to as the wheels 108, as shown in the FIG. 1B), a platform 110 (as shown in the FIG. 1B), at least one movable rod 112 (hereinafter referred to as the movable rod 112, as shown in the FIG. 1B), and one or more mounting brackets 114a-114b (hereinafter referred to as the mounting brackets 114, as shown in the FIG. 1B). The first set of components of the trailer 100 may be discussed in detail in conjunction with the FIG. 1B.

Further, in an embodiment of the present invention, the frame 102 may be made up of a material such as, but not limited to, steel material, aluminum material, composite material, alloy material, and so forth. In a preferred embodiment of the present invention, the frame 102 may be constructed of steel. Embodiments of the present invention are intended to include or otherwise cover any type of the material of the frame 102 including known related art and/or later developed technologies. In an embodiment of the present invention, the frame 102 may be made up of solid components. In another embodiment of the present invention, the frame 102 may be made up of hollow components.

In an embodiment of the present invention, the tongue 104 may be an extended portion that extends forward from the frame 102. The tongue 104 may be capable to provide a support to a second set of components such as, but not limited to, a fastening means 116 (as shown in the FIG. 1B), a caster leg 118 (as shown in the FIG. 1B), a securing means 120 (as shown in the FIG. 1B), a caster wheel 122 (as shown in the FIG. 1B), a handle 124 (as shown in the FIG. 1B), a trailer electrical and light wiring 126 (as shown in the FIG. 1B), a trailer coupler 128 (as shown in the FIG. 1B), and a trailer coupler latch 130 (as shown in the FIG. 1B). The second set of components of the trailer 100 may be explained further in detail in conjunction with the FIG. 1B.

In an embodiment of the present invention, the tongue 104 may be made up of a material such as, but not limited to, the steel material, the aluminum material, the composite material, the alloy material, and so forth. Embodiments of the present invention are intended to include or otherwise cover any type of the material of the tongue 104 of the trailer 100 including known related art and/or later developed technologies.

FIG. 1B illustrates components of the trailer 100, according to an embodiment of the present invention. The trailer 100 may comprise the frame 102 and the tongue 104, as discussed above. Further, in an embodiment of the present invention, the first set of components of the trailer 100 may comprise the axle 106. The axle 106 may be a shaft supported by the frame 102. In a preferred embodiment of the present invention, the axle 106 may be provided at a rear side of the trailer 100. The axle 106 may be attached to the wheels 108a and 108b (hereinafter collectively referred to as the wheels 108) of the trailer 100, in an embodiment of the present invention. The axle 106 may be capable of transferring a weight of the trailer 100 and drive to the wheels 108, in an embodiment of the present invention. The axle 106 may be made up of a material such as, but not limited to, a chrome-molybdenum steel, a carbon steel, and so forth. Embodiments of the present invention are intended to include or otherwise cover any type of the material of the axle 106 including known related art and/or later developed technologies.

Further, the wheels 108 may be fixedly attached at a lower portion of the frame 102, in an embodiment of the present invention. In another embodiment of the present invention, the wheels 108 may be removably attached at the lower portion of the frame 102. According to an embodiment of the present invention, the wheels 108 may be provided to enable a movement of the trailer 100 when the trailer 100 is pulled by a towing vehicle (not shown) attached to the trailer 100. In an embodiment of the present invention, the wheels 108 may enable the movement of the trailer 100 to carry the trailer assembly 100 from a first location to a second location. The wheels 108 may be designed to hold tires, in an embodiment of the present invention. The tires may be, for example, tubed tires or tubeless tires, in an embodiment of the present invention. Embodiments of the present invention are intended to include or otherwise cover any type of the tires. In an embodiment of the present invention, the wheels 108 of the trailer 100 may be made up of a material such as, but not limited to, the steel material, the aluminum material, and so forth. Embodiments of the present invention are intended to include or otherwise cover any type of the material of the wheels 108 including known related art and/or later developed technologies.

Further, the trailer 100 may comprise the platform 110 that may be removably attached over the frame 102, in an embodiment of the present invention. In another embodiment of the present invention, the platform 110 may be fixedly attached over the frame 102. In an embodiment of the present invention, the platform 110 may be designed to provide a support to the aerial mast lift 132 (shown in FIG. 1C) when loaded over the trailer 100. In an embodiment of the present invention, the platform 110 may further comprise a rail (not shown) to provide support and allow movement of the aerial mast lift 132 when the aerial mast lift 132 is in a folded position. The rail may further allow a movement of the aerial mast lift 132 along the rail to a desired position on the platform 110, in an embodiment of the present invention. In another embodiment of the present invention, the rail will allow for movement of the aerial mast lift 132 in a forward and/or backward motion on the platform 110 for optimal positioning and weight distribution on the platform 110 prior to securing the aerial mast lift 132 for transport. In a preferred embodiment of the present invention, the rail may comprise a “C” channel. The platform 110 may be made up of a material such as, but not limited to, the steel material, the aluminum material, and so forth. In a another embodiment of the present invention, the platform 110 may be made up of a wooden material. Embodiments of the present invention are intended to include or otherwise cover any type of the material of the platform 110 that may be capable to provide a rigid support to the aerial mast lift 132 including known related art and/or later developed technologies. The platform 110 may be of any shape such as, but not limited to, a rectangular shape, a square shape, a parallelogram shape, multiple parallel platforms and so forth. Embodiments of the present invention are intended to include or otherwise cover any shape of the platform 110 including known related art and/or later developed technologies.

Further, in an embodiment of the present invention, the trailer 100 may further comprise a movable and/or removable rod 112. In an embodiment of the present invention, the movable rod 112 may be a movable pin. The movable rod 112 may be a central shaft and act as a pivot point for enabling ease of folding of the aerial mast lift 132 onto the trailer 100 in a horizontal position for a lower center of gravity and more even weight distribution while on the trailer 100. The movable rod 112 may be provided at a rear side of the frame 102, in an embodiment of the present invention. In such embodiment of the present invention, the movable rod 112 may be attached at the rear side of the frame 102 to the mounting brackets 114. In an embodiment of the present invention, the movable rod 112 may be attached to the mounting brackets 114 by inserting ends of the movable rod 112 into the mounting brackets 114 provided on the rear side of the frame 102. In an embodiment of the present invention, a position of the movable rod 112 within the mounting brackets 114 may be locked and/or unlocked by a pin or other retaining mechanism (not shown), in an embodiment of the present invention. The movable rod 112 may be one singular rod or two rods/pins located on opposing sides of the rear of the trailer 100.

In a preferred embodiment of the present invention, the retaining mechanism may be screws inserted inside perforations provided at the corresponding mounting brackets 114 to lock the position of the movable rod 112 from both sides. In another embodiment of the present invention, the screws may be removed from the perforations of the corresponding mounting brackets 114 to unlock the position of the movable rod 112 from both sides.

In an embodiment of the present invention, the screw may be loosened and/or tightened by a user to unlock and/or lock the movable rod 112. According to an embodiment of the present invention, at least one of, the screws may be loosened by the user to remove the movable rod 112 from the mounting brackets 114. In other words, the movable rod 112 may be pulled by the user in a backward direction upon loosening the screws.

In an embodiment of the present invention, the movable rod 112 may be retracted and pulled in the backward direction to create a space between the mounting brackets 114. In such embodiment of the present invention, the space may be created to enable the user to align a hollow rod, interchangeably referred to as a receiving handle, 134 (as shown in FIG. 1C) of the aerial mast lift 132 in between the mounting brackets 114.

Further, the movable rod 112 may be pushed by the user in a forward direction to enable the movable rod 112 to pass through the receiving handle 134 of the aerial mast lift 132 that may be aligned in between the mounting brackets 114. In an embodiment of the present invention, a length of the receiving handle 134 of the aerial mast lift 132 may be smaller than the movable rod 112 of the trailer 100. In such embodiment of the present invention, the movable rod 112 may be aligned manually by the user while passing the movable rod 112 through the receiving handles 134 of the aerial mast lift 132 to fix the ends of the movable rod 112 inside the corresponding mounting brackets 114.

In an embodiment of the present invention, screws may be tightened by the user to lock the aligned position of the movable rod 112 for securely attaching the receiving handle 134 of the aerial mast lift 132 to the trailer 100. In such embodiment of the present invention, the secure attachment of the receiving handle 134 of the aerial mast lift 132 to the trailer 100 may enable a secure loading of the aerial mast lift 132 onto the trailer 100. In an embodiment of the present invention, the secure attachment of the receiving handle 134 of the aerial mast lift 132 provides a hinge or pivot point to enable the aerial mast lift 132 to be tilted or folded in a downward position while loading the aerial mast lift 132 onto the trailer 100. In an embodiment of the present invention, the folding position of the aerial mast lift 132 may allow the lower center of gravity and allow for better weight distribution on the trailer 100.

In another embodiment of the present invention, at least one of the screws may be loosened by the user to unlock a position of the movable rod 112 to detach the receiving handle 134 of the aerial mast lift 132 from the trailer 100. In such embodiment of the present invention, the receiving handle 134 of the aerial mast lift 132 may be detached to unload the aerial mast lift 132 from the trailer 100.

Further, in an embodiment of the present invention, the mounting brackets 114 may be self-aligning for ease of securing the aerial mast lift 132 to the trailer 100. In a preferred embodiment of the invention, the trailer 100 may comprise at least one self-aligning mounting bracket 114. Further, in a preferred embodiment of the present invention, the self-aligning mounting brackets 114 may be v-mounting brackets. In an embodiment of the present invention, the self-aligning mounting brackets 114 may further comprise a securing means (not shown) to secure the aerial mast lift 132 to the trailer 100, eliminating a need for a separate movable rod 112. The aerial mast lift 132 may be secured to the mounting brackets 114 by a friction, a spring lock, a pin, or other retaining mechanism (not shown), in an embodiment of the present invention. Embodiments of the present invention are intended to include or otherwise cover any type of the retaining mechanism including known related art and/or later developed technologies. In another embodiment of the present invention, the receiving handle 134 of the aerial mast lift 132 is aligned with the self-aligning mounting brackets 114, wherein once aligned, the receiving handle 134 of the aerial mast lift 132 rests within and moves freely within the self-aligning mounting brackets 114 to form a pivot point to enable ease of folding and loading of the aerial mast lift onto the trailer in a horizontal position.

Further, in an embodiment of the present invention, the second set of components of the trailer 100 may comprise the fastening means 116 that may be provided at the tongue 104 of the trailer 100. In an embodiment of the present invention, the fastening means 116 may be provided for securing the aerial mast lift 132 when loaded onto the platform 110 of the trailer 100 in the folded position. In such embodiment of the present invention, a first end of the fastening means 116 may be attached to the tongue 104 of the trailer 100 and a second end of the fastening means 116 may be attached to the loaded aerial mast lift 132 for securely holding the aerial mast lift 132 onto the trailer 100. In a preferred embodiment of the present invention, the fastening means 116 may comprise a cable having a turnbuckle to loosen and/or regulate a tension of the cable. The fastening means 116 may be, but not limited to, winch, latch, bungee cord, and so forth. In a preferred embodiment of the present invention, the fastening means 116 may be an integrated mechanical tensioner that may be a ratchet strap. Embodiments of the present invention are intended to include or otherwise cover any type of the fastening means 116 including known related art and/or later developed technologies.

In an embodiment of the present invention, the second set of components of the trailer 100 may comprise the caster leg 118 that may be removably attached to the tongue 104 of the trailer 100. In another embodiment of the present invention, the caster leg 118 may be fixedly attached to the tongue 104 of the trailer 100. Further, in an embodiment of the present invention, the caster leg 118 may be attached to the tongue 104 of the trailer 100 by using the securing means 120. The securing means 120 may be a hinge that may be, but not limited to, a ball bearing hinge, a butt hinge, a barrel hinge, a piano hinge, and so forth, in an embodiment of the present invention. Embodiments of the present invention are intended to include or otherwise cover any type of the securing means 120 including known related art and/or later developed technologies. In an embodiment of the present invention, the securing means 120 may be adapted to enable the caster leg 118 to be folded up when the trailer 100 is hitched to the towing vehicle, in an embodiment of the present invention. In another embodiment of the present invention, the securing means 120 may be adapted to enable the caster leg 118 to be folded down when the trailer 100 is unhitched to the towing vehicle. In a preferred embodiment of the present invention, the securing means 120 may be adjustable to accommodate the aerial mast lifts 132 of different heights if necessary.

In an embodiment of the present invention, the caster leg 118 may be made up of a material such as, but not limited to, steel, aluminum, and so forth. Embodiments of the present invention are intended to include or otherwise cover any type of the material of the caster leg 118 including known related art and/or later developed technologies.

Further, in an embodiment of the present invention, the caster leg 118 may comprise a caster wheel 122 that may be designed to provide a support to the tongue 104 of the trailer 100, when the trailer 100 is not hitched to the towing vehicle. The caster wheel 122 along with the caster leg 118 may be lowered or raised by using the handle 124 attached to the caster leg 118. In an embodiment of the present invention, the caster wheel 122 along with the caster leg 118 may be lowered to provide the support to the tongue 104 of the trailer 100 when the trailer 100 is not hitched to the towing vehicle. In another embodiment of the present invention, the caster wheel 122 along with the caster leg 118 may be raised to a certain height when the trailer 100 is to be hitched with the towing vehicle. In such embodiment of the present invention, the caster wheel 122 along with the caster leg 118 may be raised to a height parallel to the tongue 104 of the trailer 100. In an embodiment of the present invention, when the caster leg 118 is fully extended and the trailer 100 is removed from the towing vehicle, then the trailer 100 may be manually pushed and maneuvered to a desired location prior to unloading of the aerial mast lift 132.

Further, in an embodiment of the present invention, the handle 124 may be a crank that may be attached to the caster leg 118 and used by the user to raise and lower the caster leg 118 along with the caster wheel 122. In an embodiment of the present invention, the handle 124 may be rotated by the user in a clockwise direction to raise the caster leg 118 along with the caster wheel 122. In another embodiment of the present invention, the handle 124 may be rotated by the user in an anti-clockwise direction to raise the caster leg 118 along with the caster wheel 122. In an embodiment of the present invention, the handle 124 may be rotated by the user in a clockwise direction to lower the caster leg 118 along with the caster wheel 122. In another embodiment of the present invention, the handle 124 may be rotated by the user in an anti-clockwise direction to lower the caster leg 118 along with the caster wheel 122.

In an embodiment of the present invention, trailer electrical and light wiring 126 may be connected to an electrical component of a trailer hitch (not shown) of the towing vehicle. In an embodiment of the present invention, the trailer hitch may be attached to the towing vehicle for connecting the trailer 100 to the towing vehicle, in an embodiment of the present invention.

In an embodiment of the present invention, the trailer coupler 128 may be provided at an end of the tongue 104 of the trailer 100. The trailer coupler 128 may be lowered or raised to attach or detach the trailer coupler 128 to or from a hitch ball (not shown) of the towing vehicle, in an embodiment of the present invention. The trailer coupler 128 may be lowered or raised by moving the handle 124 in a downward position or an upward position, in an embodiment of the present invention. In an exemplary scenario, the trailer coupler 128 may be lowered by moving the handle 124 in a downward horizontal position and the trailer coupler 128 may be raised by moving the handle 124 in the upward position. In another exemplary scenario, the trailer coupler 128 may be raised by moving the handle 124 in the downward horizontal position and the trailer coupler 128 may be lowered by moving the handle 124 in the upward position.

Further, the trailer coupler latch 130 may be provided on the top of the trailer coupler 128 to lock the trailer 100 to a rear side of the towing vehicle, in an embodiment of the present invention. In an embodiment of the present invention, a latch pin (not shown) may be used to hold the trailer coupler latch 130 in place upon attaching the trailer coupler 128 to the hitch ball of the towing vehicle. In another embodiment of the present invention, the latch pin may be removed from the trailer coupler latch 130 to detach the trailer 100 from the towing vehicle.

FIG. 1C illustrates the trailer 100 loaded with the aerial mast lift 132, according to an embodiment of the present invention. In an embodiment of the present invention, the aerial mast lift 132 may be attached directly to the trailer 100 through the movable rod 112. When inserted through the receiving handle 134 of the aerial mast lift 132, the movable rod 112 provides a pivot point for ease of folding of the aerial mast lift 132 to securely load the aerial mast lift 132 onto the trailer 100. In an embodiment of the present invention, the receiving handle 134 of the aerial mast lift 132 may be wrapped with a rubber grip. In another embodiment of the present invention, the hollow rod 134 of the aerial mast lift 132 may be wrapped with a plastic grip.

In an embodiment of the present invention, the receiving handle 134 of the aerial mast lift 132 may be connected to a body 136 of the aerial mast lift 132 through a connecting means 138. In other words, the connecting means 138 may be attached to the body 136 to provide a support to the receiving handle 134 of the aerial mast lift 132. In an embodiment of the present invention, the body 136 may comprise a rail 140 that may be connected to the connecting means 138. The rail 140 may facilitate movement and sliding of the aerial mast lift 132 in either a forward or backward direction when loaded over the trailer 100 in the folded position. In an exemplary embodiment of the present invention, the rail 140 may facilitate motion in the forward direction when the user pushes the loaded aerial mast lift 132 in the forward direction. In such embodiment of the present invention, the rail 140 may facilitate motion in the forward direction to maneuver the aerial mast lift 132 onto the platform 110 of the trailer 100 at a desired location.

In another exemplary embodiment of the present invention, the rail 140 may facilitate the motion in the backward direction when the user pulls the loaded aerial mast lift 132 in the backward direction. In such embodiment of the present invention, the rail 140 may facilitate motion in the backward direction to enable the user to unload the aerial mast lift 132 from the trailer 100. In an embodiment of the present invention, the motion may be enabled by a plurality of ball bearings (not shown) installed in the connecting means 138.

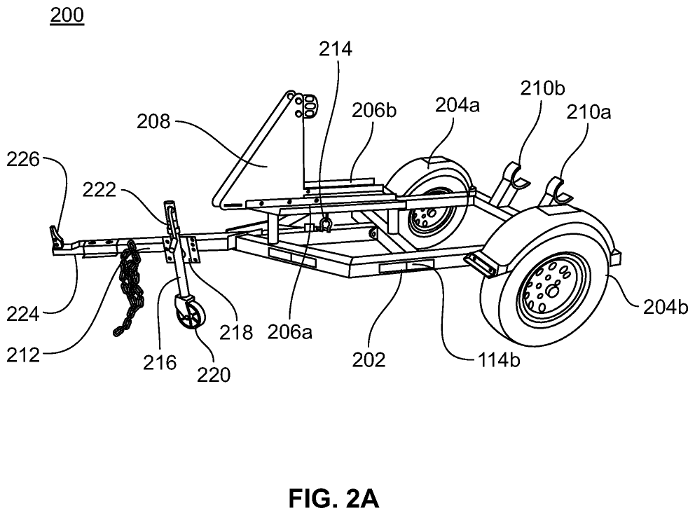

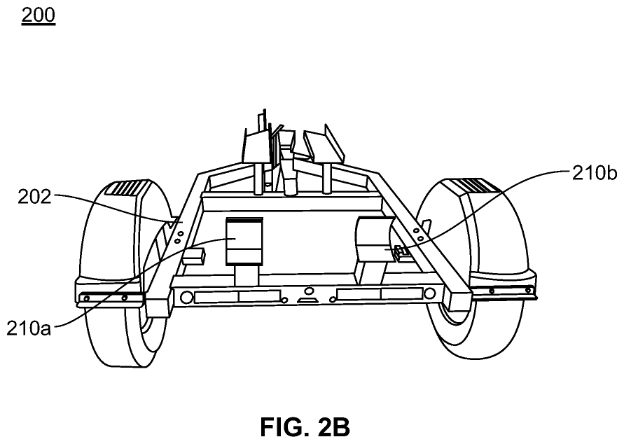

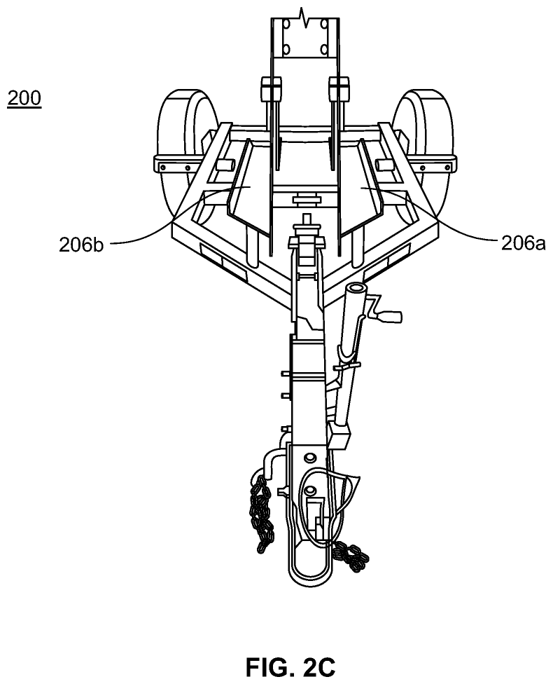

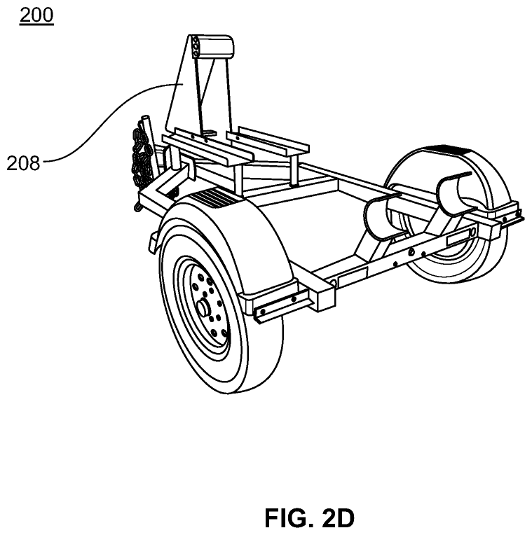

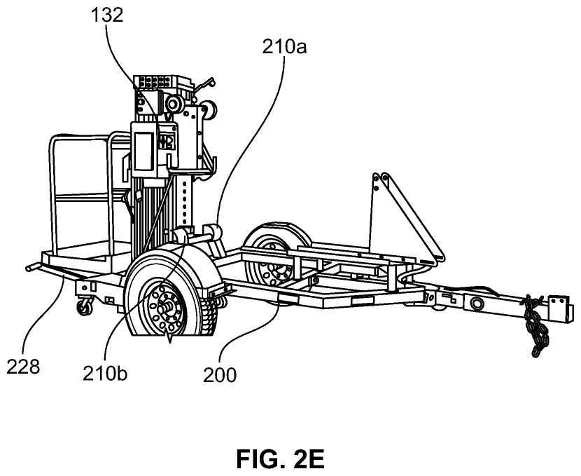

FIG. 2A illustrates a trailer 200, according to another embodiment of the present invention. In an embodiment of the present invention, the trailer 200 may comprise a frame 202. In a preferred embodiment of the present invention, the frame 202 is comprised of steel. The frame 202 may be designed to provide a support to a first set of components of the trailer 200, in an embodiment of the present invention. The first set of components may be for example, but not limited to, at least two wheels 204a-204b (hereinafter referred to as the wheels 204), one or more rails 206a-206b (hereinafter referred to as the rails 206), a bumper stop 208, and one or more mounting brackets 210a-210b (hereinafter referred to as the mounting brackets 210).

The trailer 200 may further comprise a tongue 212 that may be capable to provide a support to a second set of components such as, but not limited to, a fastening means 214, a caster leg 216, a securing means 218, a caster wheel 220, a handle 222, a trailer coupler 224, and a trailer coupler latch 226.

FIG. 2B illustrates a rear view of the trailer 200, according to another embodiment of the present invention. In an embodiment of the present invention, the mounting brackets 210 may be attached at the rear side of a frame 202. The mounting brackets 210 may be self-aligning mounting brackets that may be capable to receive the receiving handle 134 (as shown in the FIG. 1C) of the aerial mast lift 132 (as shown in the FIG. 1C). In other words, the receiving handle 134 of the aerial mast lift 132 may be positioned in alignment with the self-aligning mounting brackets 210 on the trailer 200, thereby eliminating a use of the movable rod 112 (as shown in the FIG. 1B). In an embodiment of the present invention, once aligned, the receiving handle 134 of the aerial mast lift 132 moves freely within the self-aligning mounting bracket to form a pivot point to enable ease of folding and loading of the aerial mast lift onto the trailer 200 in a horizontal position. In a preferred embodiment of the present invention, the receiving handles 143 of the aerial mast lift 132 are not attached to the self-aligning mounting brackets 210 of the trailer 200 but rather rest within the self-aligning brackets 210 to form a fulcrum and/or pivot point for ease of folding the aerial mast lift 132 onto the trailer 200. The self-aligning design of the mounting brackets 210 aids in the alignment process, enables a smooth and reliable fitting without a need for intricate adjustments. In a preferred embodiment of the present invention, the mounting brackets 210 may be designed in a “C” shape having an opening sufficient to accept the receiving handle 134 of the mounting bracket aerial mast lift 132. In a preferred embodiment of the present invention, the “C” shaped design allows the receiving handles 134 of the aerial mast lift to rotate or pivot within the mounting brackets 210 for ease of folding the aerial mast lift 132 in a forward and downward direction onto the trailer 200.

FIG. 2C illustrates a front view of the trailer 200, according to another embodiment of the present invention. The trailer 200 may comprise rails 206 that may enable the aerial mast lift 132 to move in a forward direction on the trailer 200, when the aerial mast lift 132 is in a folded position onto the trailer 200. In a preferred embodiment of the present invention, each of the rails 206 may comprise a “C” channel.

FIG. 2D illustrates a side view of the trailer 200, according to another embodiment of the present invention. In an embodiment of the present invention, the trailer 200 may comprise the bumper stop 208 that may serve as a stopping point for the movement of the aerial mast lift 132 along the rails 206 and prevents the aerial mast lift 132 from moving beyond a certain point on the trailer 200. In a preferred embodiment of the present invention, the bumper stop 208 may be of a triangular shape. Embodiments of the present invention are intended to include or otherwise cover any shape of the bumper stop 208 including known related art and/or later developed technologies.

FIG. 2E illustrates the aerial mast lift 132 placed behind the trailer 200 in a vertical position, according to another embodiment of the present invention. In an embodiment of the present invention, the aerial mast lift 132 may be placed behind the trailer 200 before loading the aerial mast lift 132 onto the trailer 200. In an embodiment of the present invention, the receiving handles of the aerial mast lift 132 may be aligned with the mounting brackets 210 of the trailer 100. Further, an additional handle 228 of the aerial mast lift 132 may be pulled out from a lower portion of the body 136 of the aerial mast lift 132 to fold and load the aerial mast lift 132 onto the trailer 200. The aerial mast lift 132 may be folded and loaded onto the trailer 200 in the horizontal position, in an embodiment of the present invention.

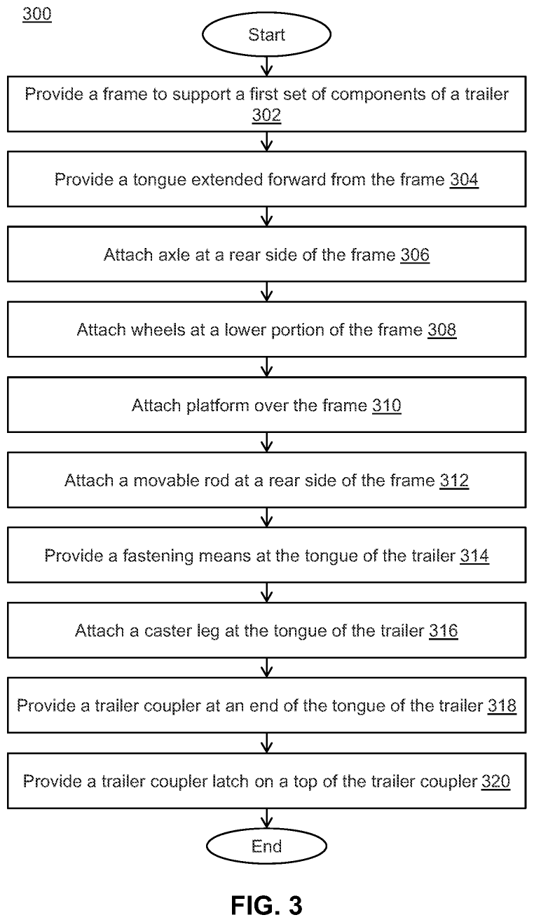

FIG. 3 illustrates a flow chart of a method 300 of manufacturing of the trailer 100, according to an embodiment of the present invention.

At step 302, the trailer 100 may be designed with the frame 102 to provide the support to the first set of components of the trailer 100.

At step 304, the trailer 100 may be designed with the tongue 104 that may be extended forward from the frame 102, to provide the support to the second set of components of the trailer 100.

At step 306, the trailer 100 may be designed with the axle 106 provided at the rear side of the frame 102.

At step 308, the trailer 100 may be designed with the wheels 108 attached at the lower portion of the frame 102, to enable the movement of the trailer 100 when the trailer 100 is pulled by the towing vehicle attached to the trailer 100.

At step 310, the trailer 100 may be designed with the platform 110 attached over the frame 102, to provide the support to the aerial mast lift 132 when loaded over the trailer 100.

At step 312, the trailer 100 may be designed with the movable rod 112 attached at the rear side of the frame 102 to the mounting brackets 114 by inserting the ends of the movable rod 112 into the mounting brackets 114. The movable rod 112 may act as the pivot point for enabling ease of folding of the aerial mast lift 132 onto the trailer 100.

At step 314, the trailer 100 may be designed with the fastening means 116 provided at the tongue 104 of the trailer 100 for securing the aerial mast lift 132 when loaded onto the platform 110 of the trailer 100 in the folded position.

At step 316, the trailer 100 may be designed with the caster leg 118 having the caster wheel 122 attached at the tongue 104 of the trailer 100, to provide the support to the tongue 104 of the trailer 100, when the trailer 100 is not hitched to the towing vehicle.

At step 318, the trailer 100 may be designed with the trailer coupler 128 provided at the end of the tongue 104 of the trailer 100. The trailer coupler 128 may be lowered or raised to attach or detach the trailer coupler 128 to or from the hitch ball of the towing vehicle.

At step 320, the trailer 100 may be designed with the trailer coupler latch 130 provided on the top of the trailer coupler 128 to lock the trailer 100 to the rear of the towing vehicle.

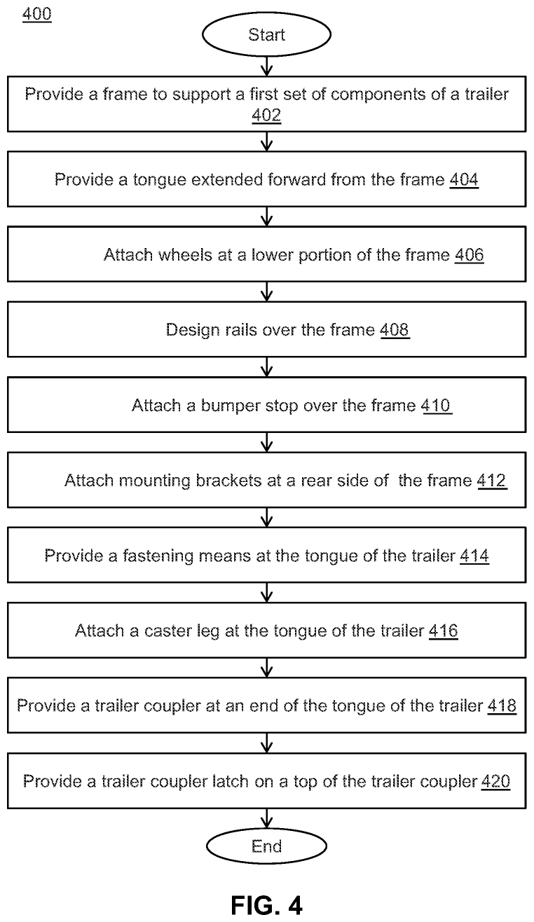

FIG. 4 illustrates a flow chart of a method 400 of manufacturing of the trailer 200, according to another embodiment of the present invention.

At step 402, the trailer 200 may be designed with the frame 202 to provide the support to the first set of components of the trailer 200.

At step 404, the trailer 200 may be designed with the tongue 212 that may be extended forward from the frame 202, to provide the support to the second set of components of the trailer 200.

At step 406, the trailer 200 may be designed with the wheels 204 attached at the lower portion of the frame 202, to enable the movement of the trailer 200 when the trailer 200 is pulled by a towing vehicle attached to the trailer 200.

At step 408, the trailer 200 may be designed with the rails 206 attached over the frame 202, to provide the support to the aerial mast lift 132 and enable the aerial mast lift 132 to move in both a forward direction and/or back direction when loaded over the trailer 200.

At step 410, the trailer 200 may be designed with the bumper stop 208 that may serve as the stopping point for the movement of the aerial mast lift 132 along the rails 206.

At step 412, the trailer 200 may be designed with the mounting brackets 210 attached at the rear side of a frame 202. The receiving handle 134 of the aerial mast lift 132 may be positioned in alignment with the self-aligning mounting brackets 210 to create pivot point for enabling ease of folding of the aerial mast lift 132 onto the trailer 200.

At step 414, the trailer 200 may be designed with the fastening means 214 provided at the tongue 212 of the trailer 200 for securing the aerial mast lift 132 when loaded onto the trailer 200 in the folded position.

At step 416, the trailer 200 may be designed with the caster leg 216 having the caster wheel 220 attached at the tongue 212 of the trailer 200, to provide the support to the tongue 212 of the trailer 200, when the trailer 200 is not hitched to the towing vehicle.

At step 418, the trailer 200 may be designed with the trailer coupler 224 provided at the end of the tongue 212 of the trailer 200. The trailer coupler 224 may be lowered or raised to attach or detach the trailer coupler 224 to or from the hitch ball of the towing vehicle.

At step 420, the trailer 200 may be designed with the trailer coupler latch 226 provided on the top of the trailer coupler 224 to lock the trailer 200 to the rear of the towing vehicle.

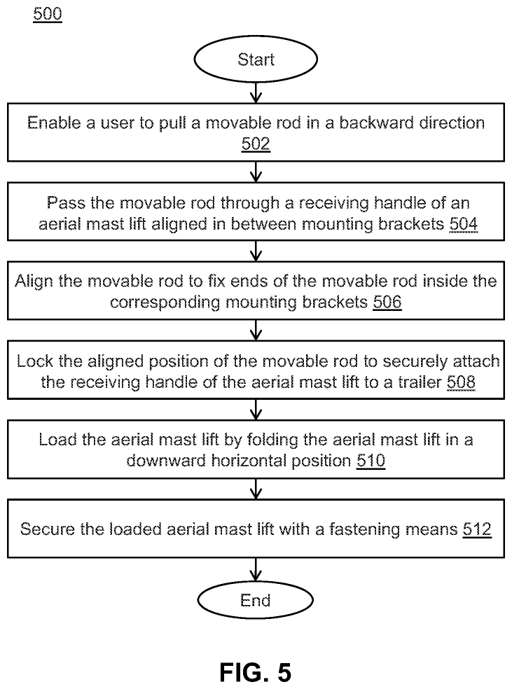

FIG. 5 illustrates a flow chart of a method 500 of loading the aerial mast lift 132 onto the trailer 100, according to an embodiment of the present invention.

At step 502, the trailer 100 may enable the user to pull the movable rod 112 fitted within the mounting brackets 114 in the backward direction to create the space between the mounting brackets 114 to align the receiving handles 134 of the aerial mast lift 132 in between the mounting brackets 114.

At step 504, the trailer 100 may enable the user to push the movable rod 112 in the forward direction to enable the movable rod 112 to pass through the receiving handles 134 of the aerial mast lift 132 aligned in between the mounting brackets 114.

At step 506, the trailer 100 may enable the user to manually align the movable rod 112 while passing the movable rod 112 through the receiving handle 134 of the aerial mast lift 132 to fix the ends of the movable rod 112 inside the corresponding mounting brackets 114.

At step 508, the trailer 100 may enable the user to lock the aligned position of the movable rod 112 by using the retaining mechanism for securely attaching the receiving handle 134 of the aerial mast lift 132 to the trailer 100.

At step 510, the trailer 100 may enable the user to load the aerial mast lift 132 onto the trailer 100 by folding the aerial mast lift 132 in the downward horizontal position upon securely attaching the receiving handle 134 of the aerial mast lift 132 with the trailer 100.

At step 512, the trailer 100 may enable the user to fasten the loaded aerial mast lift 132 by using the fastening means 116 provided at the tongue 104 of the trailer 100 to securely hold the aerial mast lift 132 onto the trailer 100.

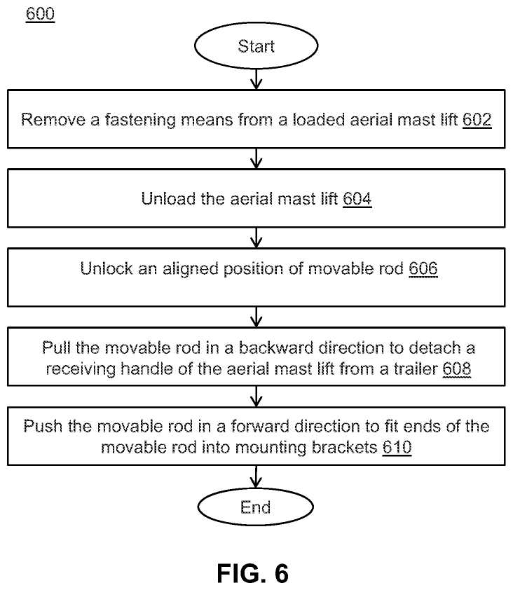

FIG. 6 illustrates a flow chart of a method 600 of unloading the aerial mast lift 132 from the trailer 100, according to an embodiment of the present invention.

At step 602, the trailer 100 may enable the user to remove the fastening means 116 from the loaded aerial mast lift 132.

At step 604, the trailer 100 may enable the user to unload the aerial mast lift 132 from the trailer 100 by unfolding the aerial mast lift 132 to a vertical position.

At step 606, the trailer 100 may enable the user to unlock the aligned position of the movable rod 112.

At step 608, the trailer 100 may enable the user to pull the movable rod 112 in the backward direction to detach the receiving handle 134 of the aerial mast lift 132 from the trailer 100.

At step 610, the trailer 100 may enable the user to push the movable rod 112 in the forward direction to fit the ends of the movable rod 112 into the mounting brackets 114 upon detaching the aerial mast lift 132 from the trailer 100.

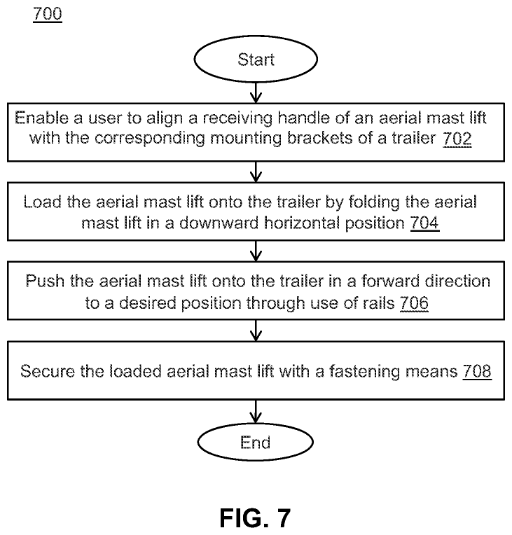

FIG. 7 illustrates a flow chart of a method 700 of loading the aerial mast lift 132 onto the trailer 200, according to another embodiment of the present invention.

At step 702, the trailer 200 may enable the user to align the receiving handle 134 of the aerial mast lift 132 with a corresponding mounting bracket 210, to create a hinge or pivot point for folding the aerial mast lift 132 onto the trailer 200.

At step 704, the trailer 200 may enable the user to load the aerial mast lift 132 onto the trailer 200 by folding the aerial mast lift 132 in the downward horizontal position upon aligning the receiving handle 134 of the aerial mast lift 132 with the mounting bracket 210 of the trailer 200.

At step 706, the trailer 200 may enable the user to position the aerial mast lift 132 in a desired position on the trailer 200 by pushing the aerial mast lift 132 in a forward direction through use of rails 206 until contact with a bumper stop 208.

At step 708, the trailer 200 may enable the user to fasten the loaded aerial mast lift 132 by using the fastening means 214 provided at the tongue 212 of the trailer 200 to securely hold the aerial mast lift 132 onto the trailer 200.

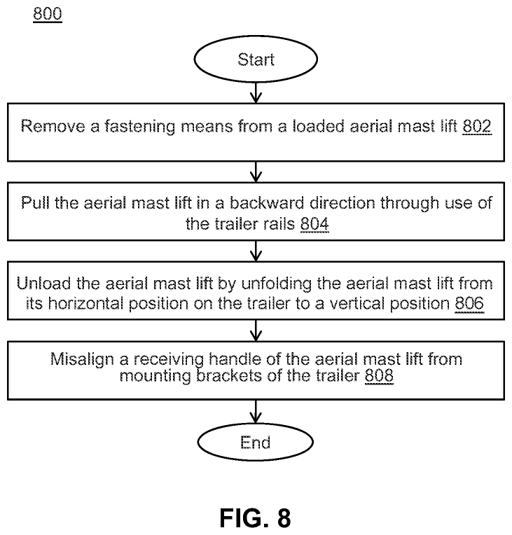

FIG. 8 illustrates a flow chart of a method 800 of unloading the aerial mast lift 132 from the trailer 200, according to another embodiment of the present invention.

At step 802, the trailer 200 may enable the user to remove the fastening means 214 from the loaded aerial mast lift 132.

At step 804, the trailer 200 may enable the user to pull the aerial mast lift 132 in the backward direction through use of the rails 206 of the trailer 200.

At step 806, the trailer 200 may enable the user to unload the aerial mast lift 132 from the trailer 200 by unfolding the aerial mast lift 132 from its horizontal position on the trailer 200 to a vertical position when unloaded.

At step 808, the trailer 100 may enable the user to misalign the receiving handle of the aerial mast lift 132 from the mounting brackets 210 of the trailer 200.

Although the invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that the appended claims be construed to cover all such equivalent variations as fall within the true spirit and scope of the invention.

The exemplary embodiments of this present invention have been described in relation to a trailer for transporting aerial mast lifts. However, to avoid unnecessarily obscuring the present invention, the preceding description omits a number of known structures and devices. This omission is not to be construed as a limitation of the scope of the present invention. Specific details are set forth by use of the embodiments to provide an understanding of the present invention. It should however be appreciated that the present invention may be practiced in a variety of ways beyond the specific embodiments set forth herein.

A number of variations and modifications of the present invention can be used. It would be possible to provide for some features of the present invention without providing others.

The present invention, in various embodiments, configurations, and aspects, includes components, methods, systems and/or apparatus substantially as depicted and described herein, including various embodiments, sub-combinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of the present invention has been presented for purposes of illustration and description. It is not intended to limit the present invention to the form or forms disclosed herein. In the foregoing Detailed Description, for example, various features of the present invention are grouped together in one or more embodiments, configurations, or aspects for the purpose of streamlining the disclosure. The features of the embodiments, configurations, or aspects may be combined in alternate embodiments, configurations, or aspects other than those discussed above. This method of disclosure is not to be interpreted as reflecting an intention the present invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate embodiment of the present invention.

Moreover, though the description of the present invention has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A trailer for transporting an aerial mast lift comprising:
a frame designed to provide support to a first set of components comprising:
a mounting bracket to accept a receiving handle of an aerial mast lift; and
a rail attached over the frame to enable movement of the aerial mast lift when the aerial mast lift is loaded onto the trailer; and
a tongue extended forward from the frame to provide support to a second set of components of the trailer.

2. The trailer of claim 1, wherein the receiving handle of the aerial mast lift moves freely within the mounting bracket to enable folding of the aerial mast lift onto the trailer in a horizontal position.

3. The trailer of claim 1, wherein the mounting bracket is self-aligning.

4. The trailer of claim 1, wherein the mounting bracket is attached to a rear side of the frame.

5. The trailer of claim 1, wherein the first set of components comprises at least two wheels attached at a lower portion of the frame to enable movement of the trailer.

6. The trailer of claim 1, wherein the rail comprises a C-channel.

7. The trailer of claim 1, wherein the first set of components further comprises a bumper stop to restrict forward movement of the aerial mast lift along the rail.

8. The trailer of claim 1, wherein the second set of components comprises a fastening means having a first end attached to the tongue of the trailer and a second end attached to the aerial mast lift for securely holding the aerial mast lift onto the trailer.

9. The trailer of claim 1, wherein the second set of components further comprises a caster leg attached to the tongue of the trailer.

10. The trailer of claim 9, wherein the caster leg comprises a caster wheel to support the tongue of the trailer.

11. The trailer of claim 10, wherein the caster leg further comprises a handle to raise and to lower the caster leg and caster wheel.

12. A trailer for transporting an aerial mast lift, comprising:
a frame designed to provide support to a first set of components comprising:
a self-aligning mounting bracket to accept a receiving handle of the aerial mast lift wherein the receiving handle moves freely within the self-aligning mounting bracket to enable the aerial mast lift to be folded horizontally onto the trailer;
a rail attached over the frame to enable movement of the aerial mast lift when the aerial mast lift is loaded onto the trailer; and
a bumper stop to restrict forward movement of the aerial mast lift along the rail; and
a tongue extended forward from the frame to provide support to a second set of components of the trailer.

13. The trailer of claim 12, wherein the rail comprises a C-channel.

14. The trailer of claim 12, wherein the first set of components comprises at least two wheels attached at a lower portion of the frame to enable movement of the trailer.

15. The trailer of claim 12, wherein the first set of components further comprises a platform attached over the frame to provide support to the aerial mast lift when loaded onto the trailer.

16. The trailer of claim 12, wherein the second set of components comprises a fastening means having a first end attached to the tongue of the trailer and a second end attached to the aerial mast lift for securely holding the aerial mast lift onto the trailer.

17. The trailer of claim 12, wherein the second set of components further comprises a caster leg attached to the tongue of the trailer.

18. The trailer of claim 17, wherein the caster leg comprises a caster wheel to support the tongue of the trailer when the trailer is unhitched from a towing vehicle.

19. The trailer of claim 18, wherein the caster leg further comprises a handle to raise and to lower the caster leg and caster wheel.

20. A method for loading an aerial mast lift onto a trailer, wherein the method comprises steps of:
enabling a user to align a receiving handle of the aerial mast lift with a corresponding self-aligning mounting bracket of the trailer so as to allow the receiving handle to move freely within the self-aligning mounting bracket;
enabling the user to load the aerial mast lift onto the trailer by folding the aerial mast lift to a horizontal position;
enabling the user to move the aerial mast lift to a desired position on the trailer by moving the aerial mast lift forward on a rail until the aerial mast lift contacts a bumper stop; and
enabling the user to fasten the aerial mast lift by using an integrated fastening means provided at a tongue of the trailer to securely hold the aerial mast lift onto the trailer.
